(19) United States
(12) Patent Application Publication
(10) Pub. No.: US 2004/0249860 A1
(43) Pub. Date: Dec. 9, 2004

(54) Apparatus for collecting, storing and transmitting fishing information

(76) Inventors: Theodore J. Stechschulte, Maumee, OH (US); Glenn E. Klopping, Millbury, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/809,000

(22) Filed: Mar. 25, 2004

Related U.S. Application Data
(60) Provisional application No. 60/457,783, filed on Mar. 26, 2003.

(51) Int. Cl. G06F 17/00

(52) U.S. Cl. 707/104.1

(57) ABSTRACT

A system for collecting, storing, processing and transmitting fishing or other sport information includes a data logging and processing module and connected sensors for automatically collecting data during participation in the sport. A data communication module collects data input by the user. Data from both modules is input into a personal computer connected to a web site that uses the data from the modules and collected related data to provide a virtual guide service.

### CROSS-REFERENCE TO RELATED APPLICATION

This application claims the benefit of U.S. provisional patent application Ser. No. 60/457,783 filed Mar. 26, 2003.

### BACKGROUND OF THE INVENTION

The present invention relates generally to an apparatus for gathering, storing and displaying information and, in particular, to a data logger device for use in connection with various sports such as fishing. The present invention also relates to a web site for transmitting to users the stored information.

This invention relates to information sharing and data recording systems useful to the sport-fishing field. More specifically, the invention relates to systems that measure and collect data for the process variables associated with fishing. Specifically, it relates to a system where data is collected automatically where possible through the use of sensors and manually through the user. In such a system, the data is then used to perform valuable scientific analysis and to capture personal memories and activities related to the sport-fishing experience. This invention is designed to improve the angler's effectiveness while also recording the richness associated with going fishing.

Sport-fishing is an activity enjoyed by the young and old, amateur and professional. Success, typically identified with catching quality fish consistently, depends on the angler's understanding of the process variables associated with fishing. Often the difference between an amateur and a professional is the development of an internal system for combing through the variables efficiently on or off the water. Equipment, such as fish finders, depth finders, chart recorders and underwater cameras, among others, has been developed to augment the angler in measuring some of these variables.

The dilemma, however, is that no current system integrates the wide variety of process variables with an effective scientific analytical tool for sport-fishing in real time. The result is that little valuable scientific analysis has been possible in this field for the average sportsman.

Anglers have had to rely on memories of past experiences, input from friends based on their experiences or input from professionals through published mediums to attempt to understand this complicated field. The sport-fishing experience is impacted dramatically by a host of process variables that change constantly over time, many that require calibrated sensors to measure. The historical angler armed with a limited number of sensors measuring a limited number of process variables was still left with the dubious task of analyzing the data in a useful way without any statistical tools. The result has been a “hit or miss” approach where anglers face a “feast or famine” outcome each and every trip.

Sport-fishing is commonly viewed as an entertainment activity to be shared with other people. It is engaged in by individuals who often wish to share their respective experiences with their fellow anglers. Photos, movies, mounted specimens and personal memories have historically been the only ways to remember and share the overall experience. As a result, there has been an unfortunate tendency to keep “trophy size” fish as proof, exaggerate the details of previous trips and events or to simply forget what actually happened as time has passed.

The U.S. Pat. No. 4,839,675 entitled “Catch and Release Fish Data Recording System” shows a device including a weighing and measuring subassembly, a data readout display, a pre-focused camera, a computer, a keyboard and a printer for recording, displaying and printing certain data concerning a fish and a fisherman.

U.S. Pat. No. 5,854,447 entitled “Electronic Fish Length Measuring Apparatus” shows an apparatus for measuring and displaying fish weight, length and/or girth of a fish in a net.

U.S. Pat. No. 6,094,996 entitled “Apparatus and Method for Measuring Size of Fish” shows an apparatus for measuring and displaying fish weight, length and/or girth of a fish in a net.

U.S. Pat. No. 6,222,449 entitled “Remote Fish Logging Unit” shows a portable device for recording information obtained from sensors of environmental conditions and/or measured physical data on a fish, and includes manual input of information and a display. The device can transmit recorded data to a network server via cellular telecommunications.

U.S. Pat. No. 6,587,740 entitled “System, Method and Computer Program Product for Determining an Angler Rating” shows a central database receiving fishing information an processing that information to generate angler ratings. Remote terminals can communicate with the database over a wide area network for inputting the information and receiving the angler ratings.

### SUMMARY OF THE INVENTION

The present invention concerns an apparatus for the sporting industry. The concept is a specialized data logger that accepts automated and manual inputs for various data fields that relate to the sportsman's field of interest. While the invention is described in terms of fishing, the data loggers can be for hunting, bird watching or other various areas of interest. The concept behind the data loggers is to gather information that allows the user to more fully understand their sport and their individual performance in that sport. The data loggers can be configured in a variety of packages ranging from the most cost effective completely manual entry units to the most sophisticated units for automatically capturing the majority of data.

The data loggers integrate GPS (latitude, longitude, altitude), compass (direction), and weather information (wind speed, wind direction, rainfall, temperature, humidity, barometric pressure, weather trends, sun intensity, etc.), along with data related to the specific area of interest. Using as an example, fishing, the additional information would include items such as water conditions (temperature, clarity, oxygen levels, etc.), bottom structure (logs, rocks, weeds, contour, etc.), bait and tackle (lures, rod, reel, etc.), sportsmen inputs (experience, location on boat, fishing pressure, lunar table, etc.), and more. The data logger software allows the user to begin with a standard set of data inputs and customize them to their specific needs.

The same type of standard inputs with custom variations would apply to big game hunting, small game hunting, bird watching and sightseeing as well as competitive sports data loggers for basketball, baseball, football, volleyball and others.

The entire product line is vertically integrated extending from the data capture unit to the desktop PC and finally to specialized sites through the use of the World Wide Web.

The PC software is designed to allow the user to customize the data loggers to meet their individual goals and specifications. Additional customization allows the user to manage their tackle and baits electronically, keeping an accurate inventory status along with where additional baits may be purchased. In addition the PC software provides extensive simulation and what if analysis from the data imported from the data logger. The same software allows, via the Internet, collection of important data such as weather forecasts, important news and events, which will feed the data logger as inputs. The software also allows users around the world to share data via a web site. The web site offers information on any fishing water previously fished by one of the users. Via e-mail, users are notified of spawning conditions, catch rates and weather conditions on their requested bodies of water, data on catch rates, boating conditions, photo opportunities and such will be shared between users. In addition, important user inputs are available such as launches, docks, cottages, restaurants, tackle and bait shops, guides and other important information for individuals planning trips.

The electronics seeks to source data either from other manufacturers' equipment via serial ports or integrate the necessary technology in the base units. The units also allow audio and visual inputs for subjective data that is difficult to anticipate and program around. Such subjective data is often critical to understanding what happened in the final analysis. The data loggers also allow the integration of communication technology including emergency location broadcasts.

The software allows individuals to play games related to the sport. It allows the sportsman to understand his/her “world” ranking. It also allows individuals to output trip itineraries for members of the group and when finished publish trip scrapbooks including photos and detailed data.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a block diagram of a data logging system in accordance with the present invention;

FIG. 2 is block diagram of the data logging and processing module, the sensors and the data communications module shown in FIG. 1;

FIG. 3 is an exploded perspective view of the data logging and processing module and hub shown in FIG. 2;

FIG. 4 is a block diagram of the handheld unit and the sensors shown in FIG. 2;

FIG. 5 is a perspective view of the data communications module shown in FIG. 4;

FIG. 6 is a perspective view of a first alternate embodiment of the data communications module shown in FIG. 1;

FIG. 7 is a perspective view of a second alternate embodiment of the data communications module shown in FIG. 1;

FIG. 8 is a perspective view of the water probe shown in FIG. 4;

FIG. 9 is a perspective view of the weather station shown in FIG. 4;

FIG. 10 is a perspective view of a mounting configuration for the handheld unit of FIG. 5 and the weather station of FIG. 9;

FIG. 11 is a perspective view of the data logging and processing module and the personal computer of FIG. 1 connected together for data transfer;

FIG. 12 is a perspective view of the data communications module of FIG. 2 and the personal computer of FIG. 1 connected together for data transfer; and

FIG. 13 is a perspective view of the weather station of FIG. 2 and the personal computer of FIG. 1 connected together for data transfer.

### DESCRIPTION OF THE PREFERRED EMBODIMENT

Overview:

The present invention concerns an integrated system, the Log It system, that collects data from a wide variety of sources that relate to process variables that impact the sport-fishing field, using those inputs to provide a pool of data that can be statistically analyzed. The analysis is designed to provide the angler with unprecedented insights into the area of sport-fishing touching on personal characteristics and performance and allowing comparison to others. In addition to the scientific value, the invention helps to capture the “fishing” experience through the integration of data with audio and video effects collected during a trip and allows the sharing of that experience with others.

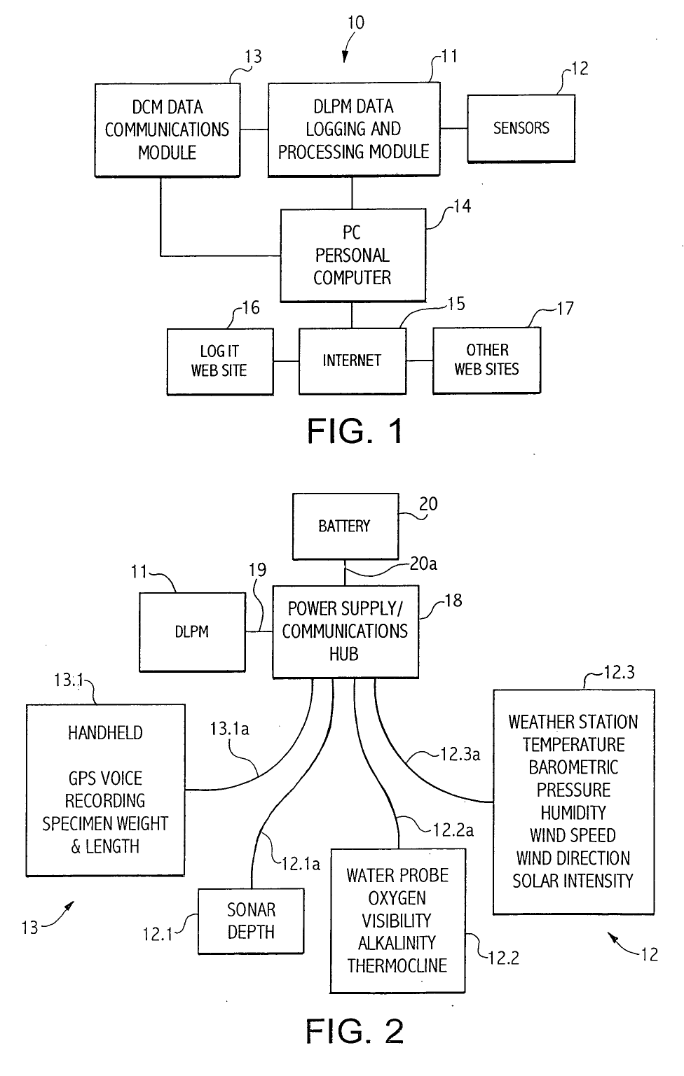

A Log It system 10 according to the present invention is shown in block diagram form in FIG. 1 and is comprised of numerous components that work as an integrated system to measure, collect, store and analyze data related to the sport-fishing field, reporting the results to the user and then allowing the data and results to be shared with others.

The major component categories are:

A Data logging and processing module (DLPM) 11 that collects, stores and analyzes data in a portable and compact unit.

A plurality of sensors 12 connected to the DLPM 11 and calibrated and used to measure some of the variables for the system 10.

A data communication module (DCM) 13 connected to the DLPM 11 that can be used to enter manual data into the system and/or view selected information.

A personal computer (PC) 14 connected to the DLPM 11 and/or the DCM 13 with software that collects, stores and analyzes data and reports results to the user.

An information source including the Internet 15, a Log It web site 16 and other web sites 17 connected to the PC 14 providing access to the algorithms developed from the universal database, maps, charts, virtual tours, software updates, and more.

Collection of Data:

Fishing is a sport that is dramatically impacted by the interplay between a large number of process variables. Time of year, time of day, weather conditions, lunar and solar cycles, water conditions, lake topography, lake vegetation and structures, fish populations, angler tendencies and capabilities, boat conditions, fishing rigs and lures and bait presentation all work together to produce the “fishing experience”.

The specific variable data values do not give, in and of themselves, a complete picture. The stability or trending of variables over time and with respect to time represents yet another class of process variables.

The following lists identify some of the major aspects and uses of the system 10 for logging fishing data according to the present invention.

1) Fishing Data Capture: GPS, Latitude, Longitude, Altitude, Speed, Direction, and Time of Day.

2) Fish Finder: Water Depth, Water Temperature, Bottom Profile and Fish Occupancy.

3) Weather Station: Air Temperature, Wind Direction, Wind Speed, Sunlight Monitor, Precipitation Monitor, Barometric Pressure, Water Alkalinity, Oxygen Content and Humidity.

4) Internet: Weather Forecasts for Specific Area, Lunar Tables, Weather Trends, Water Table Histograms, Lake Contours and Sunrise/Sunset Times.

5) Human Inputs: Fish Species, Fish Sex, Fish Weight, Fish Length, Fish Girth, Structure, Lure, Tackle, Water Clarity, Vegetation Present, Fish Food Chain (Stomach Contents, etc.), Retrieve Profile, Fishing Pressure, Number of Casts/Attempts, Fisherman Skill, Fisherman Location in Boat, Pictures of Fish, Pictures of Lure, Pictures of Fisherman, Pictures of Vegetation and Recordings of Fisherman.

6) Computer Inputs: Tackle Box Data, Lure Type, Lure Name, Lure Manufacturer, Lure Part Number, Lure Place of Purchase, Quantity on Hand, Equipment Data, Rod Information, Reel Information, Line Information, Boat Information, Motor Information, Other, Fish Condition, Mutations and Miscellaneous.

7) Fishing Data Use: Event, Episode and Trip Data Review; Boat Movement Plots; Fish Catches with All Data; Summary Reports; and Fishermen Comparison.

8) What If Analysis: Compare With Previous Trips.

9) Voice and Audio Recorder

10) 911 Distress Output

11) Ranking System (Worldwide or Local Water)

12) Trophy Log—by fish type

13) Tackle Box Inventory

14) Fishing Pro Tips and Suggestions

15) Lake Databases

16) Trip Planning

17) Advertisement Tie In

18) Weather Forecasts

19) Safe Harbor Locator

20) Alarm Points, underwater debris, etc.

21) First Aid Assists, information, tips

22) Manuals, boats, motors, fishing tackle

23) Network Capability

24) Fishing Games

25) Local Games/Local Groups

26) Internet Games/Worldwide Groups

27) Scientific Outputs

28) Fish Food Chain Analysis

The Log It system 10 of FIG. 1 is an integrated combination of units that pulls data from a variety of resources and publishes that data in a user friendly and definable way. The system 10 allows useful analysis of meaningful information that previously was too difficult to capture and to use. There is shown in FIG. 2 a block diagram of the DLPM 11, the sensors 12 and the DCM 13 in accordance with the present invention. The apparatus includes a power supply/communications hub 18 connected to the DLPM 11 by a connector means 19 such as a plug connector. The hub 18 is connected to a power source 20, such as a battery, by a connector means 20a. The power source 20 can be, for example, an internal rechargeable battery and/or a boat battery supplying power for starting the engine, lights, electronics, and the like.

The sensors 12 can include a depth finder unit 12.1, such as a sonar device, connected to the hub 18 by a connector means 12.1a such as a cable. The unit 12.1 acquires and transmits to the DLPM 11 data related to water depth, bottom contour and fish location. A water probe sensor unit 12.2 is connected to the hub 18 by a connector means 12.2a such as a cable. The unit 12.2 acquires and transmits to the DLPM 11 such data as oxygen content of the water, water visibility, water alkalinity and thermocline. The thermocline is an area of water within a water column in which the warmer upper waters are prevented from mixing with the waters at a deeper level. This barrier prevents the interchange of nutrients between the two and so in a way produces two separate environments for creatures that inhabit the body of water. A weather station sensor unit 12.3 is connected to the hub 18 by a connector means 12.3a such as a cable. The unit 12.3 acquires and transmits to the DLPM 11 data related to air temperature, barometric pressure, humidity, wind speed, wind direction and solar intensity.

The DCM 13 can be a handheld data input unit 13.1 that is connected to the hub 11 by a connector means 13.1a such as a plug connector or a cable. The unit 13.1 acquires and transmits to the DLPM 11 such data as GPS information, voice recording, specimen weight and specimen length.

Data points gathered as inputs for the process variables used in the fishing information system 10 according to the present invention are collected from a wide variety of sources. The first source includes the sensors 12, such as the units 12.1, 12.2, 12.3 described above, mounted on anglers' boats or other structures. The second source includes the actual anglers who are fishing who can enter information with the DCM 13, such as the handheld unit 13.1. The third source includes other anglers who employ the system 10 according to this invention. The fourth source includes third-party equipment, electronic files and sensors. The fifth source includes audio and video devices. The sixth source includes this invention's Internet web site(s) 16. The seventh source includes published information from other general sources such as books, magazines and other web sites 17.

The process variables are associated with one of three general categories. Category I includes process variables associated with the macro-environment and include general weather conditions, general water conditions, lunar and solar cycles, general bottom topography and general fish populations. Category II includes process variables associated with the micro-environment and include location, localized weather conditions, localized water conditions, localized fish populations, localized bottom topography, localized vegetation and structures and boat conditions. Category III includes process variables associated with the actual fishing experience and include angler tendencies and capabilities, fishing rigs and lures and bait presentation.

Each piece of data collected for Category I is marked with a time and date stamp (month, day, year, hour, minute and second), real-time or estimated, and stored in the database. Data collected for Categories II and II are always real-time data and marked with the actual time and date stamp.

The data is collected in one of two ways. Where possible, data is automatically collected by the DLPM 11 or other components of the system 10 according to the present invention. Where not possible or practical, data is collected manually through the user.

There are three times when data is collected. The first time is prior to a fishing trip when the user collects data for specific variables about the location and to help in planning the excursion. The second time is during the actual trip. The system 10 collects, either automatically or through the user, data that records the entire experience as it unfolds. This data allows the user to analyze the experience and modify their inputs in a way that will produce the most favorable outcome. The third time is after the trip when the user can audit, and if necessary, edit the collected data.

At this point, the system has collected a substantial number of data points that all relate to the fishing experience.

Uses of Data:

Once data has been collected and stored in an efficient manner, avenues for its potential use become almost endless. In the following sections some of the general uses for the data are identified.

Generation of a scientific database related to the sport-fishing field populated with quality data is the backbone of any meaningful scientific analysis. The data generated through the use of this system according to the present invention by users all over the world will create an opportunity for the advancement of science in ways unheard of before. The raw data when analyzed over time also provides additional data related to historical trends.

Scientific analysis of raw data and trends have little value in and of themselves. The database created by this invention will be used to conduct scientific analysis related to the sport-fishing field. Utilizing statistical methods and techniques, the raw data will be analyzed and a series of algorithms developed that will be useful to the average angler.

Predictions—the algorithms will allow the user to predict, based on historical information, what might work under current or assumed conditions. The user has the ability to query the system based on any set of process variables. The system responds by generating a list of suggestions designed to optimize the angler's chances of success.

Comparison—the system allows the user to conduct comparisons for any process variable. As a result, the user can make quick and efficient choices between competing options.

Personal improvement—the system will allow the users to review their individual performance in a variety of ways. The outcome is that the angler is able to identify personal strengths and weaknesses and through information generated by the system, and determine an action plan for correcting deficiencies.

Sharing with others—the system is designed to gather data related to scientific analysis but also data related to the “fishing” experience. The user has the ability to combine both types of data, facts and photos, numbers and audio bytes, and to share the output with others. The result is an expansion of the user's database and the ability to create trip memorabilia. Sharing data also allows professionals to virtually share their hotspots and techniques with amateurs for a fee.

Charting—the system utilizes the database to generate a variety of charts. Bottom contours, weed population, fish population, navigation aids, shorelines, structures are examples.

Navigation—the system can generate navigation aids related to depth, structures, historical routes, channels and shortest distance between points.

Weather forecasts—the system, utilizing the onboard weather station and in conjunction with general weather information can forecast weather.

Games—the system allows users to compete in a variety of games designed around the fishing experience. The games can be for local participants only or allow the comparison and competition of remote parties.

Tackle box management—the system allows the users to manage their fishing gear and tackle. Inventory status, suggested re-order points, suggested purchases of new items, online purchasing of items and maintenance reminders associated with fishing gear are examples.

Trip planning—the system helps the user plan excursions by identifying potential bodies of water which hold promise. The system also identifies and connects the user with providers of food, lodging, gas, licenses and bait and tackle in the surrounding area.

Auto-suggestions—the system, responding the user directed guidelines and utilizing digitized speech technology can automatically notifies the angler of significant changes in specified variables. The system also suggests changes in inputs that would typically work in the current conditions.

Tournament support—the system supports the tournament angler in a variety of ways. Culling management and suggestions, live well conditions, estimated time to return to dock in addition to the other features of the system provide a competitive edge.

Safety support—the system provides a variety of safety enhancements. Depth alarms, structure alarms, navigation aids, help system with first aid instructions and maritime laws work together to improve safety on the water.

Help system—the system, drawing from the universal database provides a wide variety of helpful information. The system covers areas of technique, tackle and baits, boat troubleshooting, first aid, fishing rules and regulations and maritime laws.

Fisheries management—the system database provides significant insight into the sport-fishing field on a body of water by body of water basis. As a result, natural resource officials have insight in unprecedented ways related to the health of specific lakes and streams as well as specific species.

Typical Form of Invention:

The system 10 according to the present invention, as stated above, is comprised of numerous components that work as an integrated system to measure, collect, store and analyze data related to the sport-fishing field, reporting the results to the user and then allowing the data and results to be shared with others.

The DLPM 11, shown in FIGS. 1 and 2, is designed to be flexible in form and use. The DLPM 11 is semi-portable and is designed to be used on a boat and in the home. The DLPM 11 can be connected to a variety of the sensors 12 used to collect the type(s) of data desired by the end-user. The sensors 12 are designed to be permanently mounted on a boat or structure with their terminations ending at a connection base (CB), the hub 18, for the DLPM 11. The DLPM 11 serves the functions of data logger and central processing unit.

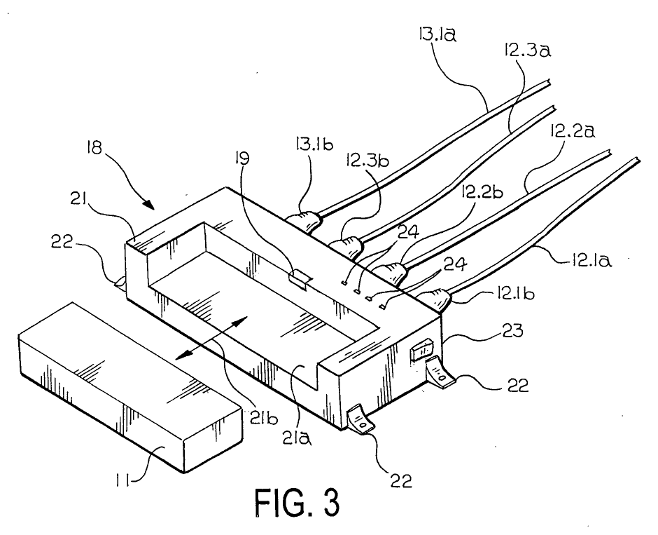

As shown in FIG. 3, the hub 18 includes a housing 21 having a docking cutout 21a sized to releasably receive the DLPM 11 which is adapted to be inserted and removed in the direction of an arrow 21b. A male electrical connector part (not shown) of the connector plug 19 is mounted on the rear of the DLPM 11 and mates with a female electrical connector part 19 on the housing 21 for transferring electrical power and data signals. The housing 21 has a plurality of mounting brackets 22 attached thereto for securing the housing to a suitable surface on the boat. A power switch 22 is mounted on the housing 21 can be used to turn on and off the electrical power supplied through the connector 19 and through the cables 12.1a, 12.2a, 12.3a, 13.1a. The cables 12.1a, 12.2a, 12.3a, 13,1a terminate in waterproof plugs 12.1b, 12.2b, 12.3b, 13.1a respectively that mate with connectors (not shown) on a rear surface of the housing 21. A plurality of status indicators 23, such as LED lamps, are provided on an upper surface of the housing 21 to indicate the status of, for example, the power switch 22 and the data transfer on the cables.

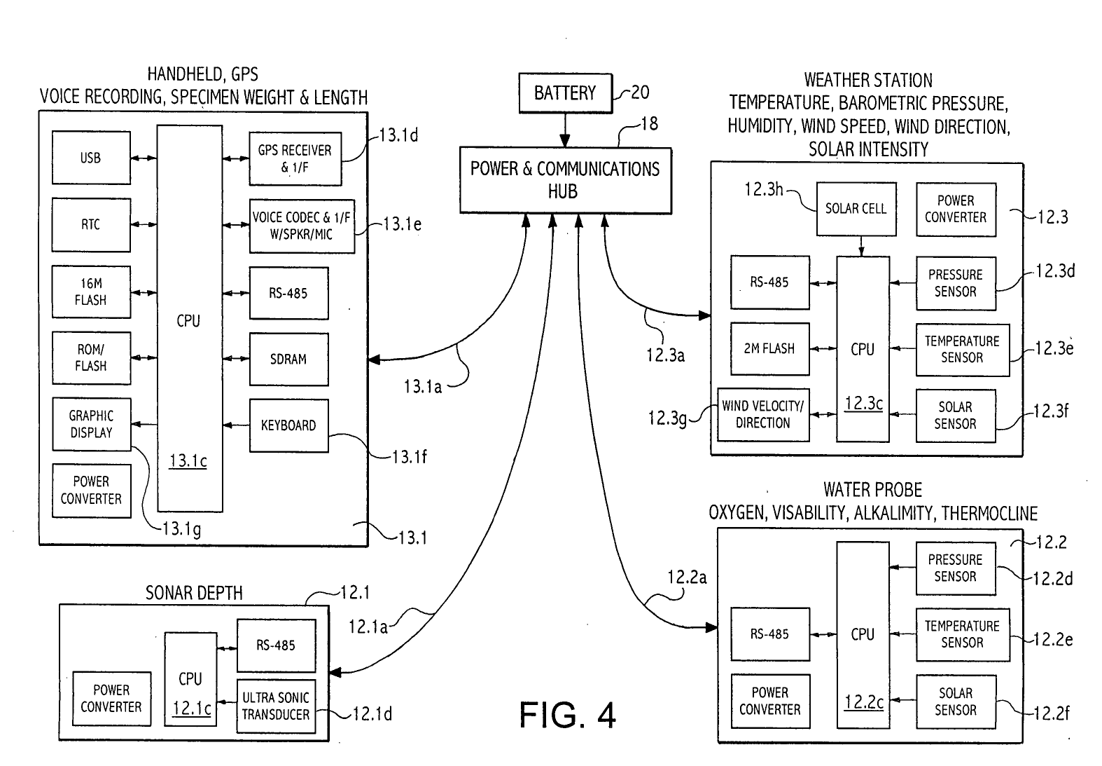

The handheld unit 13.1 and the sensors 12.1, 12.2, 12.3 are shown in more detail in FIG. 4. The handheld unit 13.1 includes a central processing unit (CPU) 13.1c connected to various input and output devices for collecting, processing, storing and transmitting data. A GPS receiver and I/F device 13.1d provides position data to the CPU 13.1c. A voice recognition and I/F device 13.1e provides audio data to the CPU 13.1c. A keyboard 13.1f provides manual data input to the CPU 13.1c. A graphic display 13.1g provides visual data to the user.

The sonar unit 12.1 includes a central processing unit (CPU) 12.1c connected to an ultrasonic transducer 12.1d for collecting, processing, storing and transmitting depth and object data.

The water probe unit 12.2 includes a central processing unit (CPU) 12.2c connected to various input devices for collecting, processing, storing and transmitting data. A pressure sensor 12.2d, a temperature sensor 12.2e and a solar sensor 12.2f are examples of such input devices.

The weather station unit 12.3 includes a central processing unit (CPU) 12.3c connected to various input devices for collecting, processing, storing and transmitting data. A pressure sensor 12.3d, a temperature sensor 12.3e a humidity sensor 12.2f, a wind velocity/direction sensor 12.3g and a solar cell 12.3h are examples of such input devices.

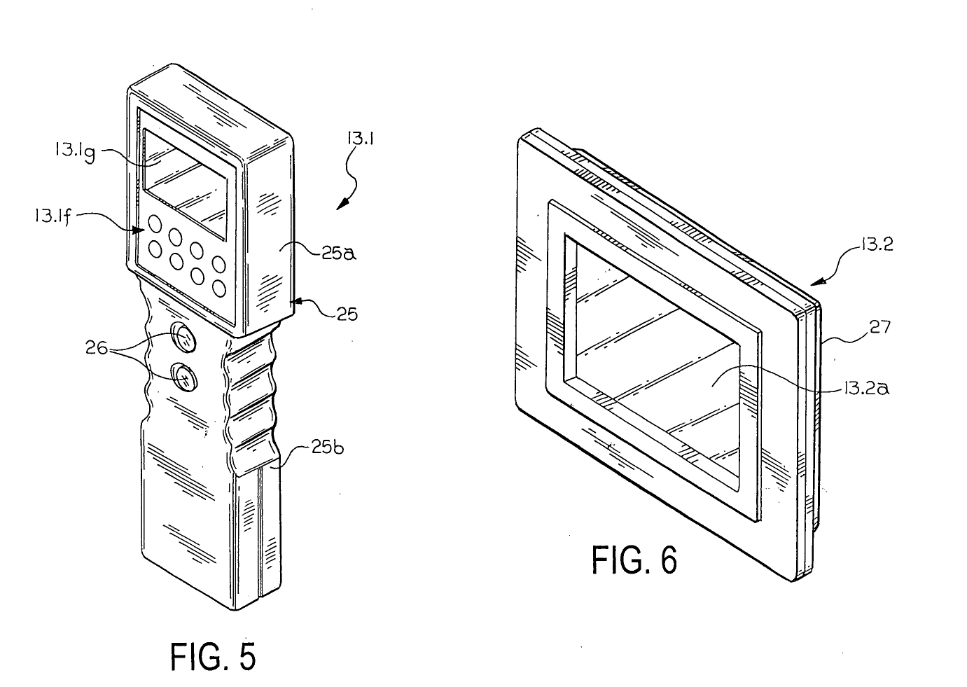

One form of the handheld unit 13.1 is shown in FIG. 5. A rugged, waterproof housing 25 has a head portion 25a mounting the keyboard 13.1f and the display 13.1g. A pair of buttons 26 is mounted on a handle portion 25b of the housing 25 for performing functions such as power on/off and microphone on/off.

An alternate embodiment DCM 13 is shown in FIG. 6 as a data entry panel 13.2. The panel 13.2 has a housing 27 in which a touch screen 13.2a is mounted to perform the functions of the keyboard 13.1f and the display 13.1g of the handheld unit 13.1 shown in FIG. 5.

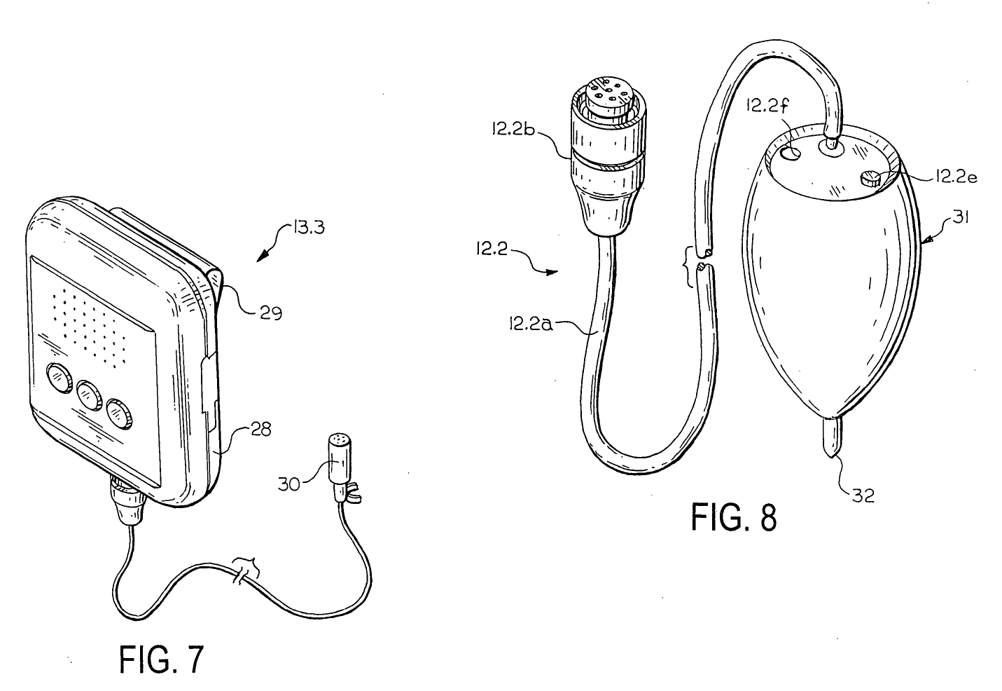

The functions of the DCM 13 can be divided into two or more separate devices. For example, a second alternate embodiment DCM 13 is shown in FIG. 7 as a wireless data recorder 13.3. The recorder 13.3 has a housing 28 including a belt clip 29 for fastening to the clothing of a user. An omni-directional mini-lapel microphone is connected to the housing 28. The recorder 13.3 can communicate with the voice recognition circuit 13.1e shown in FIG. 4 by radio frequency transmission or the like.

The sensor units 12.1, 12.2, 12.3 are designed to be rugged and durable. Each sensor is individually calibrated at the time of manufacture and where possible to be re-calibrated by the end user at home over time. Others requiring delicate or sophisticated calibration will be conducted through the manufacturer. The calibrated sensors are critical for the accurate collection of reliable data that provide the basis for scientific evaluation. Types of sensors are:

Water Profile: water temperature sensor, alkalinity sensor, turbidity sensor, flow sensor, depth sensor, thermocline sensor, dissolved oxygen sensor.

Weather Profile: air temperature, humidity, barometric pressure, precipitation, sunlight intensity, wind direction, wind speed.

Location Profile: compass, latitude, longitude, altitude.

There is shown in FIG. 8 an example of the water probe 12.2 of FIG. 4. The probe 12.2 has a housing 31 upon which are mounted the temperature sensor 12.2e and the solar sensor 12.2f in the form of a photocell to measure visibility and clarity. An ISFET sensor 32 extends from the bottom of the housing 31 for measuring water pH. The pressure sensor 12.2d is internal to the housing 31. The dissolved oxygen can be calculated from the pressure and temperature measurements.

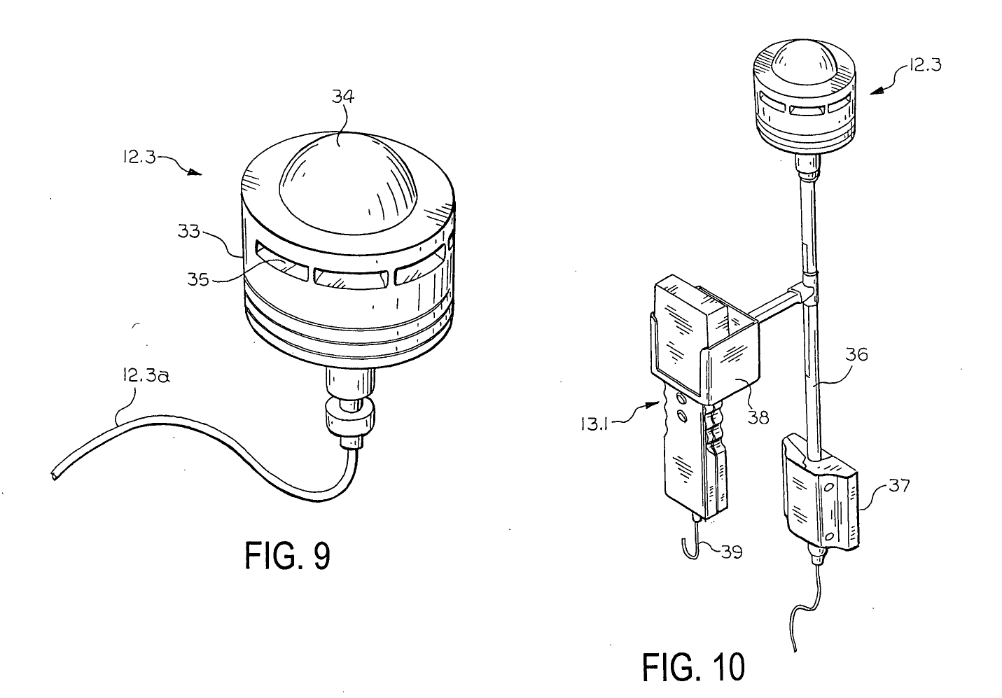

There is shown in FIG. 9 an example of the weather station 12.3 of FIG. 4. The station 12.3 has a housing 33 upon which is mounted a dome 34 enclosing the solar cell 12.3h. The housing 33 has a plurality of slots 36 formed in the side wall for receiving air to be exposed to the pressure sensor 12.3d in the form of a MAP sensor to measure atmospheric pressure, the temperature sensor 12.3e in the form of a thermistor, the humidity sensor 12.3f in the form of a hygrometer, the wind velocity/direction sensor 12.3g in the form of a hot wire vector anemometer, and compass for measuring heading/direction.

There is shown in FIG. 10 a mounting configuration for the handheld unit 13.1 of FIG. 5 and the weather station 12.3 of FIG. 9. A vertically extending mounting post 36 as the weather station 12.3 attached at an upper end. A lower end of the post 36 is attached to a mounting bracket 37 that can be mounted at a convenient location on a boat (not shown). A holder 38 extends transversely from the post 36 and releasably receives the handheld unit 13.1. A hook 39 extends from the bottom of the handheld unit 13.1 and can be attached to an internal weighing device (not shown) for obtaining fish weight.

The system 10 software and hardware design is flexible and allows for the addition of new sensor technologies and new types of sensor inputs over time as required to support the end user's future needs and wishes.

The data communication modules (DCM 13) are numerous and varied in design as described above. The simplest is the handheld unit 13.1 of FIG. 5 that allows the entry of data through a simple keypad with the help of a graphically displayed menu. Expanded versions of this type, such as the data entry panel 13.2 of FIG. 6, employ touch screens and serve the dual purpose of being onboard analytical and information review stations. Another type of DCM 13.3 of FIG. 7 incorporates wired or wireless microphones that allow the user through manual or voice activated triggers to input manual data as voice recordings that are later entered in the system through the use of another DCM or through the system program as data values. The system 10 is also designed to allow the collection of manual data through the data entry panels of third-party products.

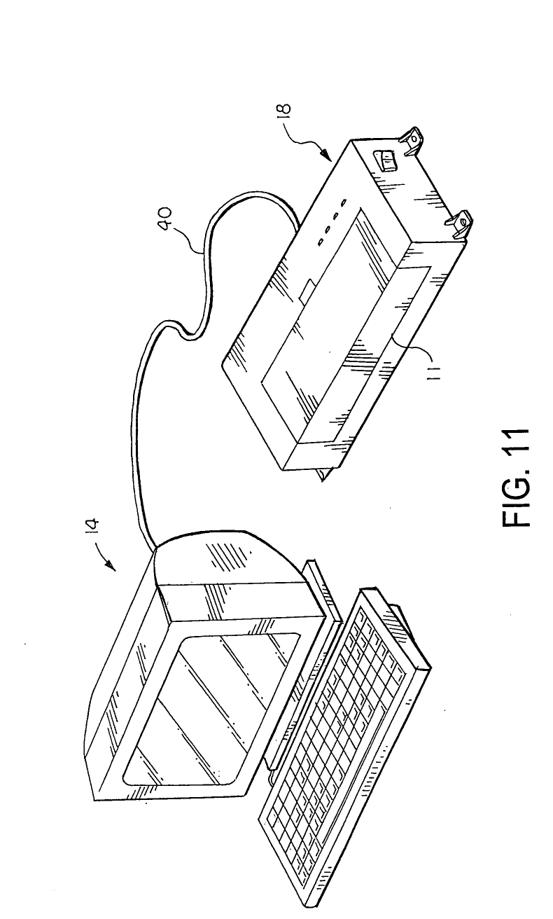

The personal computer software (PCS) of the system 10 automatically downloads data from the DLPM as it is plugged into the home CB. As shown in FIG. 11, the DLPM 11 is docked in the CB or hub 18 that is connected to the personal computer 14 by a cable 40. The data is added to the database that contains all of the historical data ever collected in the system where it is maintained based on the time and date it was recorded. The PCS is then used to complete the data sets by polling the user for manual entries that were omitted or for converting the audio entries into data points the computer can recognize.

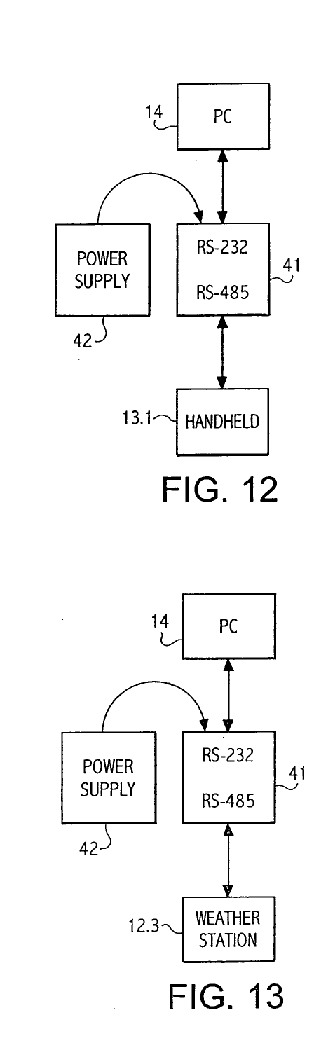

As shown in FIG. 12, the handheld unit 13.1 of FIG. 2 can be connected directly to the personal computer 14 for data transfer through a connector adapter 41 powered by a power supply 42. As shown in FIG. 13, the weather station 12.3 of FIG. 2 can be connected directly to the personal computer 14 for data transfer through the connector adapter 41 powered by the power supply 42.

The PCS also allows the user to enter other types of data into the database where, if applicable, it is synchronized based on time and date. Examples include images from a digital camera camcorder, voice recorder, and Internet information. The PCS is designed to allow the images that have a time and date stamp to be automatically synchronized with the DLPM data whereby pictures taken of fish will be automatically linked to the data collected for the same event. If the picture is not time and date stamped, the user can manually link the images to fish events manually.

The PCS is a powerful statistical tool that allows the user to do a multitude of things such as:

1. Review fishing trips in detail, event by event.

2. Statistically evaluate individual performance compared to previous trips and compared to other fishermen.

3. Perform user defined “what if analyses” with any of the collected data.

Examples might include the following:

What combination of weather conditions produce the highest catch rates?

What lures work best under what conditions?

Where were fish caught previously on this body of water?

What lures work best at what depths?

What color of lure works best based on a variety of weather conditions?

What lures work best for whom?

What suggestions would the computer make given the forecasted weather conditions for a pending trip?

4. Share data with others

Trip data with others with as little or as much detail as desired.

The Internet web sites 16 provide access to the algorithms developed from the universal database, maps, charts, virtual tours, software updates, and more. It is a method of acquiring and sharing information related to the sport-fishing experience.

Process Variable families and sources:

Date and Time—DLPM 11 electronics

Weather Conditions

1.) Localized air temperature—Auto

2.) Localized wind direction—Auto

3.) Localized wind speed—Auto

4.) Localized solar intensity—Auto

5.) Localized precipitation—Auto

6.) Localized barometric Pressure—Auto

7.) Localized humidity—Auto

8.) Localized wind chill—Auto/Calculated

9.) Localized heat index—Auto/Calculated

10.) Localized air temperature trend—Auto/Calculated

11.) Localized wind direction trend—Auto/Calculated

12.) Localized wind speed trend—Auto/Calculated

13.) Localized solar intensity trend—Auto/Calculated

14.) Localized precipitation trend—Auto/Calculated

15.) Localized barometric pressure trend—Auto/Calculated

16.) Localized humidity trend—Auto/Calculated

17.) Localized wind chill trend—Auto/Calculated

18.) Localized heat index trend—Auto/Calculated

19.) General air temperature—User

20.) General wind direction—User

21.) General wind speed—User

22.) General solar intensity—User

23.) General precipitation—User

24.) General barometric Pressure—User

25.) General humidity—User

26.) General wind chill—User

27.) General heat index—User

28.) Forecasted air temperature—User

29.) Forecasted wind direction—User

30.) Forecasted wind speed—User

31.) Forecasted solar intensity—User

32.) Forecasted precipitation—User

33.) Forecasted barometric Pressure—User

34.) Forecasted humidity—User

35.) Forecasted wind chill—User

36.) Forecasted heat index—User

Water Conditions

1.) Localized water temperature—Auto

2.) Localized alkalinity—Auto

3.) Localized turbidity—Auto

4.) Localized flow—Auto

5.) Localized depth—Auto

6.) Localized dissolved oxygen—Auto

7.) Localized surface conditions—Auto

8.) Localized fish population—Auto/Calculated

9.) General water temperature—Auto

10.) General alkalinity—Auto

11.) General turbidity—Auto

12.) General flow—Auto

13.) General depth—Auto

14.) General dissolved oxygen—Auto

15.) General surface conditions—Auto

16.) General fish population—Auto

Boat Conditions

1.) Location (Latitude, Longitude. Altitude)—Auto

2.) Speed—Auto

3.) Heading—Auto

4.) Orientation—Auto

5.) Battery status—Auto

6.) Engine status—Auto

7.) Live well status—Auto

8.) Fuel level—Auto

9.) Oil level—Auto

Angler

1.) Name—User

2.) Age—User

3.) Sex—User

4.) Height—User

5.) Weight—User

6.) Photo—User

7.) Address—User

8.) Skill level—Calculated

9.) Location on boat—User

10.) Quantity on boat—User

11.) Start time—User

12.) Stop time—User

13.) Misc. note—User

Rig

1.) Rod type—User

2.) Rod length—User

3.) Rod action—User

4.) Rod manufacturer—User

5.) Rod model—User

6.) Reel speed—User

7.) Reel manufacturer—User

8.) Reel model—User

9.) Line weight—User

10.) Line manufacturer—User

11.) Line model—User

12.) Leader type—User

13.) Leader length—User

14.) Lure type—User

15.) Lure color—User

16.) Lure weight—User

17.) Lure mm depth—User

18.) Lure max depth—User

19.) Blade combination—User

20.) Lure manufacturer—User

21.) Lure model—User

22.) Live bait type—User

23.) Live bait condition—User

24.) Bait/Lure Modifications—User

25.) Special Equipment—User

26.) Target Depth—User

Presentation

1.) Type—User

2.) Action—User/Auto

3.) Speed—User/ Auto

4.) Depth—User

5.) Direction—User

6.) Line out—User

Cover

1.) Type—User

2.) Density—User

3.) Type2—User

4.) Density2—User

Structure

1.) Type l—User

2.) Density 1—User

3.) Type 2—User

4.) Density 2—User

Bottom

1.) Hardness—Auto

General Food Chain Activity

1.) Species—User

2.) Action—User

Localized Food Chain Activity

1.) Species—User

2.) Action—User

Event

1.) Type—User

2.) Photo—User

3.) Movie—User

4.) Audio—User

5.) Time—Auto

Episode

1.) Type—User

2.) Name—User/Auto

3.) Start time—User

4.) End Time—User

Fish

1.) Species—User

2.) Sex—User

3.) Length—User

4.) Weight—User

5.) Girth—User

6.) Condition—User

7.) Markings—User

Other

1.) Lunar cycles—User/Auto

2.) Solar cycles—User/Auto

The data entered by users of the system 10 can be stored at the web site 16 and made available over the Internet for enhancing the fishing experience. For example, the data stored in the system 10 can be used in a “virtual guide service” to help the user plan excursions by identifying potential bodies of water which hold promise and providing the associated fishing data. The system 10 also identifies and connects the user with providers of food, lodging, gas, licenses and bait and tackle in the surrounding area.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A data logging system for sports, comprising:
a data logging and processing first module for collecting, storing and analyzing data related to a sport, said first module being configured in a portable and compact unit;
a plurality of sensors connected to said first module for measuring predetermined variables related to the sport and providing data representing the variables to said first module;
a data communication second module for entry of data;
a personal computer selectively connected to said first module and said second module and running software that collects, stores and analyzes the data from to said first module and said second module and reports results to a user; and
an Internet web site providing access to said personal computer for receiving information from said personal computer related to the data and for providing to said personal computer other information related to the sport.

2. The system according to claim 1 including a hub for releasably docking said first module and connecting said first module to said sensors.

3. The system according to claim 1 wherein said sensors include at least one of a sonar unit, a water probe and a weather station.

4. The system according to claim 3 wherein said sonar unit includes an ultrasonic transducer.

5. The system according to claim 3 wherein said water probe includes at least one of a pressure sensor, a temperature sensor, a solar sensor and an alkalinity sensor.

6. The system according to claim 3 wherein said weather station includes at least one of a solar sensor, a pressure sensor, a temperature sensor, a humidity sensor, a wind velocity/direction sensor and a heading/direction sensor.

7. The system according to claim 1 wherein said second module is a handheld unit having a keyboard for entering the data and a display for viewing the data.

8. The system according to claim 1 wherein said second module is a data entry panel having a touch screen for entering the data and for viewing the data.

9. The system according to claim 1 wherein said second module is a wireless data recorder having a microphone for entering the data.

10. A data logging system for providing virtual guide fishing information, comprising:
a plurality of data logging and processing first modules for collecting, storing and analyzing data related to fishing, each said first module being configured in a portable and compact unit;
a plurality of sensors associated with and connected to each said first module for measuring predetermined variables related to fishing and providing data representing the variables to said first module;
a plurality of data communication second modules for manual entry of data;
an Internet web site providing access to said first and second modules through personal computers of users for receiving information from said first and second modules related to the fishing data and for providing to the users through the personal computers virtual guide information related to fishing.

11. The system according to claim 10 including a hub for releasably docking one of said first modules and connecting said first module to said associated sensors.

12. The system according to claim 10 wherein said sensors include a sonar unit having an ultrasonic transducer.

13. The system according to claim 10 wherein said sensors include a water probe having at least one of a pressure sensor, a temperature sensor, a solar sensor and an alkalinity sensor.

14. The system according to claim 10 wherein said sensors include a weather station having at least one of a solar sensor, a pressure sensor, a temperature sensor, a humidity sensor, a wind velocity/direction sensor and a heading/direction sensor.

15. The system according to claim 10 wherein at least one of said second modules is a handheld unit having a keyboard for entering the data and a display for viewing the data.

16. The system according to claim 10 wherein at least one of said second modules is a data entry panel having a touch screen for entering the data and for viewing the data.

17. The system according to claim 10 wherein at least one of said second modules is a wireless data recorder having a microphone for entering the data.

18. A data logging system for fishing information, comprising:
a data logging and processing first module for collecting, storing and analyzing data related to fishing;
a plurality of sensors connected to said module for measuring predetermined variables related to fishing experiences and providing data representing the variables to said first module;
a data communication second module for entry of data related to fishing experiences;
a personal computer selectively connected to said first module and said second module and running software that collects, stores and analyzes the data from to said first module and said second module and reports results to a user; and
an Internet web site providing access to said personal computer for receiving information from said personal computer related to the data and for providing to said personal computer other information related to fishing.

19. The system according to claim 18 wherein said Internet web site provides fishing excursion plans identifying potential bodies of water which hold promise and including associated fishing data obtained from said first and second modules.

20. The system according to claim 19 wherein said Internet web site identifies as the other information at least one of providers of food, lodging, gas, licenses and bait and tackle in an area surrounding one of the potential bodies of water.
